(19) United States
(12) Patent Application Publication
(10) Pub. No.: US 2026/0311449 A1
(43) Pub. Date: Oct. 8, 2026

(54) METHOD AND APPARATUS FOR MANAGING GALLERY USED FOR MULTI-CAMERA ASSOCIATED TRACKING OF ARBITRARY OBJECT

(71) Applicants: HYUNDAI MOTOR COMPANY, Seoul (KR); Kia Corporation, Seoul (KR)

(72) Inventor: Yongsang YOON, Hwaseong-si (KR)

(21) Appl. No.: 19/433,192

(22) Filed: Dec. 26, 2025

(30) Foreign Application Priority Data
Apr. 3, 2025 (KR) 10-2025-0043283

(51) Int. Cl. G06V 10/74; G06T 7/246; G06V 10/44; G06V 10/75

(52) U.S. Cl. CPC G06V 10/761; G06T 7/248; G06V 10/44; G06V 10/751

(57) ABSTRACT

A method for managing a gallery for multi-camera associated tracking of an arbitrary object includes extracting a first feature and a first identifier of a first object from an image obtained using a camera; determining a second object most similar to the first object from the gallery that pre-stores the feature and identifier of at least one tracking target object; determining an assigned identifier for the first identifier based on a match determination between the first identifier of the first object and a second identifier of the second object; and managing the gallery to store or delete at least one of the first feature and the first identifier by referring to the assigned identifier for the first identifier.

### CROSS-REFERENCE TO RELATED APPLICATION

This application claims priority to and the benefit of Korean Patent Application No. 10-2025-0043283 filed with the Korean Intellectual Property Office on Apr. 3, 2025, the entire contents of which are incorporated herein by reference.

### BACKGROUND

A multi-camera associated tracking technology refers to a technology in which cameras disposed in different locations cooperate to continuously track a moving object and analyze its behavior, thus minimizing a blind spot for the object and enabling more precise surveillance.

With the recent rapid advancement of image processing technology, the multi-camera associated tracking technology is being utilized in various industries such as smart city security surveillance, traffic management, industrial security, military, and national defense.

### SUMMARY

The present disclosure relates to a method and an apparatus for managing a gallery used for multi-camera associated tracking of an arbitrary object.

Aspects of the present disclosure provide a method for managing a gallery that detects an arbitrary object in an image obtained using a camera, extracts the feature and identifier of the arbitrary object, limits similarity range for the feature and the identifier, and recursively determines an identity of the object without duplication, thereby allowing the feature or the identifier to be stored in or deleted from the gallery.

In addition, aspects of the present disclosure provide a method for managing a gallery that enables real-time processing for object tracking by limiting the number of features of an arbitrary object in the gallery.

However, technical aspects of the present disclosure are not limited to those mentioned above, and other aspects not mentioned here can be clearly understood by those skilled in the art from the following description.

According to an Implementation, provided is a method for managing a gallery used for multi-camera associated tracking of an arbitrary object, the method including: extracting the first feature and first identifier of a first object from an image obtained using a camera; determining a second object most similar to the first object from the gallery that pre-stores the feature and identifier of at least one tracking target object; determining an assigned identifier for the first identifier based on a match determination between the first identifier of the first object and a second identifier of the second object; and managing the gallery to store or delete at least one of the first feature and the first identifier by referring to the assigned identifier for the first identifier.

The extracting of the first feature and first identifier of the first object can include extracting the first feature by inputting an image into an object detection model, and extracting the first identifier by inputting the extracted first feature to an object identification model.

The determining of the second object most similar to the first object can include determining cosine similarity between the feature of the at least one tracking target object and the first feature, and determining a tracking target object whose cosine similarity exceeds a predetermined threshold value among the at least one tracking target object as the second object.

If a plurality of tracking target objects have cosine similarities exceeding the predetermined threshold value, the determining of the tracking target object as the second object can include determining a match between the plurality of tracking target objects and the first object based on a match determination between identifiers of the plurality of tracking target objects and the first identifier, and determining an object different from the first object among the plurality of tracking target objects as the second object by referring to the cosine similarity.

If the first identifier and the second identifier do not match each other, the determining of the assigned identifier for the first identifier can include performing the match determination between the first identifier and the second identifier multiple times based on a comparison between predetermined consecutive frames each including the first object and predetermined consecutive frames each including the second object.

The determining of the assigned identifier for the first identifier can include determining the assigned identifier for the first identifier as the second identifier based on verifications of a match determination indicating that the first identifier and the second identifier not matching each other less than a predetermined number of verifications.

The determining of the assigned identifier for the first identifier can include determining the assigned identifier for the first identifier as the first identifier if the first identifier does not match either the second identifier or a third identifier of a third object included in the gallery based on a predetermined number or more verifications.

The determining of the assigned identifier for the first identifier can include determining the assigned identifier for the first identifier as the third identifier if the first identifier does not match the second identifier and matches the third identifier based on the predetermined number or more verifications.

If the assigned identifier for the first identifier is the first identifier, the managing of the gallery can include storing the first identifier and the first feature in the gallery to include the first object in the tracking target objects.

If the assigned identifier for the first identifier is the second identifier or the third identifier, the managing of the gallery can include storing the first feature as a second feature of the second object or a third feature of the third object, and deleting the second feature or the third feature pre-stored in the gallery by considering the number of second features or the number of third features allowable in the gallery.

According to another Implementation, provided is an apparatus for managing a gallery used for multi-camera associated tracking of an arbitrary object, the apparatus including: a memory for storing a program for managing a gallery; and a processor configured to load the program for managing a gallery from the memory and execute the program for managing a gallery, wherein the processor is configured to extract the first feature and first identifier of a first object from an image obtained using a camera, determine a second object most similar to the first object from the gallery that pre-stores the feature and identifier of at least one tracking target object, determine an assigned identifier for the first identifier based on a match determination between the first identifier of the first object and a second identifier of the second object, and manage the gallery to store or delete at least one of the first feature and the first identifier by referring to the assigned identifier for the first identifier.

The processor can be configured to extract the first feature by inputting an image into an object detection model, and extract the first identifier by inputting the extracted first feature to an object identification model.

The processor can be configured to determine cosine similarity between the feature of the at least one tracking target object and the first feature, and determine a tracking target object whose cosine similarity exceeds a predetermined threshold value among the at least one tracking target object as a second object.

If the first identifier and the second identifier do not match each other, the processor can be configured to perform verification of the match determination between the first identifier and the second identifier based on a comparison between predetermined consecutive frames each including the first object and predetermined consecutive frames each including the second object.

The processor can be configured to determine the assigned identifier for the first identifier as the second identifier based on verifications of a match determination indicating that the first identifier and the second identifier not matching each other less than a predetermined number of verifications.

The processor can be configured to determine the assigned identifier for the first identifier as the first identifier if the first identifier does not match either the second identifier or a third identifier of a third object included in the gallery based on a predetermined number or more verifications.

The processor can be configured to determine the assigned identifier for the first identifier as the third identifier if the first identifier does not match the second identifier and matches the third identifier based on the predetermined number or more verifications.

If the assigned identifier for the first identifier is the first identifier, the processor can be configured to store the first identifier and the first feature in the gallery to include the first object in the tracking target objects.

If the assigned identifier for the first identifier is the second identifier or the third identifier, the processor can be configured to store the first feature as a second feature of the second object or a third feature of the third object, and delete the second feature or the third feature pre-stored in the gallery by considering the number of second features or the number of third features allowable in the gallery.

According to yet another Implementation, provided is a computer-readable recording medium storing a computer program, wherein the computer program includes an instruction that causes a processor to perform a method for managing a gallery, the method including extracting the first feature and first identifier of a first object from an image obtained using a camera, determining a second object most similar to the first object from the gallery that pre-stores the feature and identifier of at least one tracking target object, determining an assigned identifier for the first identifier based on a match determination between the first identifier of the first object and a second identifier of the second object, and managing the gallery to store or delete at least one of the first feature and the first identifier by referring to the assigned identifier for the first identifier.

### BRIEF DESCRIPTION OF THE DRAWINGS

FIG. 1 is a block diagram showing an apparatus for managing a gallery according to an Implementation.

FIG. 2 is a block diagram conceptually showing a function of a program for managing a gallery according to an Implementation.

FIG. 3 is a flowchart showing a method for managing a gallery used for multi-camera associated tracking for an arbitrary object according to an Implementation.

FIG. 4 is a diagram showing an example of determining a second object most similar to a first object when a plurality of tracking target objects have cosine similarities exceeding a predetermined threshold value according to an Implementation.

FIG. 5 is a diagram showing an example of determining an assigned identifier for a first identifier based on a match determination between the first identifier of the first object and a second identifier of the second object according to an Implementation.

### DETAILED DESCRIPTION

Various advantages and features of the present disclosure and methods accomplishing the same are apparent from Implementations described in detail below together with the accompanying drawings. However, the present disclosure is not limited to the Implementations disclosed below, and can be implemented in various different forms. These Implementations are provided only to make the present disclosure complete and allow those skilled in the art to completely appreciate the scope of the present disclosure, and the present disclosure is defined only by the scope of the claims. As discussed above, with the recent rapid advancement of image processing technology, the multi-camera associated tracking technology is being utilized in various industries. However, the technology in the related art may have difficulty in maintaining consistency of the tracked object, such as misassociation of an object having similar appearances when the same object is captured using various cameras at different angles, lighting, and resolutions.

In addition, the technology in the related art may have a limitation in that sensing and tracking the object in real time in a high-resolution image may require a large amount of computational resources, and real-time processing may be difficult due to network load.

To overcome such difficulty and limitation, a gallery, which is a database used for object detection and tracking algorithms, can be utilized. However, there is still insufficient discussion on a specific methodology for dynamically managing (or constructing) the gallery in a real environment where an arbitrary object appears.

Aspects of the present disclosure provide a technology for managing a dynamic gallery that maintains consistency of the object, in the real environment where the arbitrary object appears, by considering its poses, illumination, and background changes from various cameras, while enabling real-time processing.

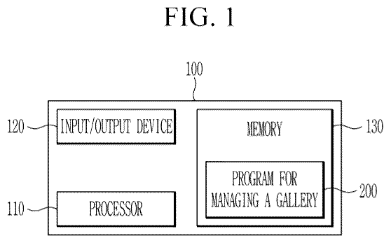

FIG. 1 is a block diagram showing an apparatus for managing a gallery according to an Implementation.

Referring to FIG. 1, an apparatus 100 for managing a gallery can include a processor 110, an input/output device 120, and a memory 130.

The processor 110 can control overall operations of the apparatus 100 for managing a gallery.

The processor 110 can receive image data including at least one frame for an arbitrary object by using the input/output device 120.

In detail, the processor 110 can receive the image data including at least one frame for the arbitrary object from an image obtained using a camera.

For convenience of description, in this specification, the image data including at least one frame for the arbitrary object is described as being input using the input/output device 120, and the present disclosure is not limited thereto. That is, according to an Implementation, the apparatus 100 for managing a gallery can include a transceiver, and the apparatus 100 for managing a gallery can receive the image data including at least one frame for the arbitrary object by using the transceiver, and the image data including at least one frame for the arbitrary object can be collected or generated within the apparatus 100 for managing a gallery.

The processor 110 can extract the feature and identifier of the arbitrary object from the image obtained using at least one camera, repeatedly compare the extracted data with existing data stored in the gallery to check for similarity, and store or delete at least one of the feature and identifier of the object in or from the gallery if a predetermined reference is satisfied.

The input/output device 120 can include at least one input device and/or at least one output device. For example, the input device can include a microphone, a keyboard, a mouse, a touchscreens, or the like, and the output device can include a display, a speaker, or the like.

The memory 130 can store a program 200 for managing a gallery and information necessary for executing the program 200 for managing a gallery.

In this specification, the program 200 for managing a gallery refers to software that includes instructions for managing a gallery that caused at least one of a feature and a first identifier of a first object extracted from at least one image obtained using at least one camera to be stored in or deleted from the gallery.

The processor 110 can load the program 200 for managing a gallery and the information necessary for executing the program 200 for managing a gallery from the memory 130 to execute the program 200 for managing a gallery.

The processor 110 can extract the first feature and first identifier of the first object from the image obtained using the camera, determine a second object most similar to the first object from the gallery that pre-stores the feature and identifier of at least one tracking target object, determine an assigned identifier for the first identifier based on a match determination between the first identifier of the first object and a second identifier of the second object, and manage the gallery to store or delete at least one of the first feature and the first identifier by referring to the assigned identifier for the first identifier.

In the present disclosure, the gallery can refer to a database (DB) used in a process for tracking and re-identifying the arbitrary object, and can be a reference for comparison when a specific object is sensed again by another camera. The gallery can store the image, feature, and identifier of the specific object.

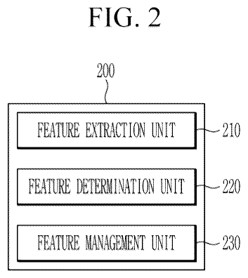

The description describes functions and/or operations of the program 200 for managing a gallery in detail with reference to FIG. 2.

FIG. 2 is a block diagram conceptually showing the functions of a program for managing a gallery according to an Implementation.

Referring to FIG. 2, the program 200 for managing a gallery can include a feature extraction unit 210, a feature determination unit 220, and a feature management unit 230.

The feature extraction unit 210, the feature determination unit 220, and the feature management unit 230 shown in FIG. 2 conceptually classify the functions of the program 200 for managing a gallery in order to easily describe the functions of the program 200 for managing a gallery, and the present disclosure are not limited thereto. According to an Implementation, respective functions of the feature extraction unit 210, the feature determination unit 220, and the feature management unit 230 can be merged/separated into or from one another, and implemented as a series of instructions included in a single program.

First, the feature extraction unit 210 can extract the first feature and the first identifier of the first object from the image obtained using the camera.

Here, the first object according to an Implementation can be any arbitrary moving object included in an image including a plurality of frames, and can include any moving object such as a person or an animal.

In detail, the feature extraction unit 210 can extract the first feature by inputting the image into an object detection model. The first feature according to an Implementation can indicate a feature for detecting, sensing, or identifying the first object, and can include, for example, a bounding box including the first object and a feature vector for the bounding box.

For example, the feature extraction unit 210 can input the image to a You Only Look Once (YOLO)-X (YoloX) model for identifying the object and detect a first bounding box.

In addition, the feature extraction unit 210 can extract the first identifier by inputting the first feature into an object identification model. The first identifier according to an Implementation can indicate a unique visual feature that can be derived from an appearance of the first object as an identity of the first object, and can include, for example, an appearance feature vector of the first object.

For example, the feature extraction unit 210 can extract a first appearance feature vector by inputting the first bounding box into Fast Re-identification (FastReID) model or Progressive Architecture Search Strategy for Re-identification (PASS-ReID) model to determine an identifier for maintaining object identification consistency across the plurality of cameras.

In this way, in the present disclosure, the object detection model can be used to determine the bounding box (i.e., a cropped image instead of an original image) that includes an object, and the object identification model can be used to determine the appearance feature vector from the bounding box, thereby extracting an identifier for maintaining the consistency of the arbitrary object across the plurality of cameras.

Meanwhile, types of the object detection model and the object identification model according to an Implementation are only examples and can be changed in various ways within the scope for achieving an object of the present disclosure.

Next, the feature determination unit 220 can determine the second object most similar to the first object from the gallery that pre-stores the feature and identifier of at least one tracking target object.

Here, the gallery according to an Implementation can include a vector cluster generated based on the feature and identifier of each of at least one tracking target object. For example, the vector cluster can be generated based on a feature vector that has cosine similarity value within a predetermined error (e.g., 10%) of the greatest cosine similarity value determined for the specific object.

In detail, the feature determination unit 220 can determine the cosine similarity between the feature of at least one tracking target object and the first feature, and determine the tracking target object whose cosine similarity exceeds the predetermined threshold value among at least one tracking target object as the second object.

For example, the feature determination unit 220 can determine cosine similarity between the feature vector included in each vector cluster and the feature vector for the first bounding box, and determine an object corresponding to a feature vector whose cosine similarity exceeds the predetermined threshold value as the second object most similar to the first object.

Meanwhile, if a plurality of tracking target objects have cosine similarities exceeding the predetermined threshold value, the feature determination unit 220 can determine a match between the plurality of tracking target objects and the first object based on a match determination between identifiers of the plurality of tracking target objects and the first identifier.

For example, the feature determination unit 220 can determine the match between the plurality of tracking target objects and the first object based on a match determination between the appearance feature vector included in each vector cluster and the first appearance feature vector of the first object.

Here, the vector cluster of the object matched to the first object among the plurality of tracking target objects can be temporarily deleted from the gallery.

Next, the feature determination unit 220 can determine an object different from the first object among the plurality of tracking target objects as the second object by referring to the cosine similarity.

In detail, if the vector cluster of the object matched to the first object in the gallery is temporarily deleted, the feature determination unit 220 can determine the cosine similarity between the feature vector included in each vector cluster included in the gallery and the feature vector of the first bounding box, and determine an object corresponding to a feature vector having the highest cosine similarity as the second object.

Next, the feature determination unit 220 can determine the assigned identifier for the first identifier based on the match determination between the first identifier of the first object and the second identifier.

Here, the assigned identifier for the first identifier can indicate an identifier of the first object, which is determined secondarily based on recursive verification within the gallery.

In detail, if the first identifier and the second identifier are simply matched to each other, the feature determination unit 220 can determine the assigned identifier for the first identifier as the second identifier.

Meanwhile, according to an Implementation, a problem can occur in which the first identifier and the second identifier simply do not match each other.

For example, the case where the first identifier and the second identifier simply do not match each other can include cases where an existing person re-enters a field of view of the camera after moving out of the field of view of the camera, a new person appears, the identifier is changed during object tracking or identification (ID) switches where different objects share the same identifier, and a change in an external factor (e.g., illumination, pose, background, or the like) causes the similarity to exceeds similarity range, or the like.

Here, the feature determination unit 220 can perform verification of the match determination between the first identifier and the second identifier based on a comparison between predetermined consecutive frames each including the first object and predetermined consecutive frames each including the second object.

For example, in a single verification of the match determination, the feature determination unit 220 can determine the number of frames in which the bounding boxes of the first object and the second object overlap each other (i.e., overlapping frames), based on the predetermined consecutive frames respectively obtained from a first object image and a second object image.

Here, the feature determination unit 220 can determine that the first identifier and the second identifier match each other if the number of overlapping frames is greater than or equal to a predetermined number or an average number of overlapping frames for the identifiers in the gallery (e.g., 5).

In addition, if there is a mismatch even after the single verification, the feature determination unit 220 can perform the verification of the match determination repeatedly multiple times based on adjustment of the predetermined consecutive frames obtained from the image.

In more detail, the feature determination unit 220 can determine the assigned identifier for the first identifier as the second identifier if verifications of a match determination indicating that the first identifier and the second identifier not matching each other are less than a predetermined number of verifications (e.g., 5 times).

In this way, the consistency of object tracking can be maintained even when the similarity exceeds the similarity range due to a temporary error caused by the change in the external factor.

Meanwhile, the feature determination unit 220 can compare the first object with a third object included in the gallery if the first identifier does not match the second identifier based on the predetermined number or more verifications.

In more detail, the feature determination unit 220 can determine the assigned identifier for the first identifier as the first identifier if the first identifier does not match either the second identifier or a third identifier of the third object included in the gallery based on the predetermined number or more verifications (e.g., 5 times).

Considering the features and identifiers stored in the gallery, this case indicates that no object matches the first object, and the first object can be treated as a new object.

In addition, the feature determination unit 220 can determine the assigned identifier for the first identifier as the third identifier if the first identifier does not match the second identifier based on the predetermined number or more verifications (e.g., 5 times) and matches the third identifier included in the gallery.

In this way, in the present disclosure, the assigned identifier for the specific object can be determined based on primary comparison with the feature and identifier of an object most similar to the specific object, and secondary comparison with an object included in the gallery based on the recursive verification, thereby preventing an identifier of a single object from being assigned multiple times.

Next, the feature management unit 230 can manage the gallery to store or delete at least one of the first feature and the first identifier by referring to the assigned identifier for the first identifier.

In detail, the feature management unit 230 can store the first feature in the gallery if the first feature satisfies a predetermined condition.

The predetermined condition according to an Implementation can include a first condition that the first feature is required to satisfy a range between a minimum similarity and a maximum similarity, a second condition that the first feature is required to satisfy the average width and minimum height of the bounding box, a third condition that the bounding boxes are required to overlap each other, a fourth condition that the bounding box is required not to include another bounding box, and the like.

However, the first to fourth conditions are only examples, and can be changed in various ways within the scope for achieving the object of the present disclosure.

In addition, the feature management unit 230 can store the first feature in the gallery regardless of conditions if the number of first features of the first object stored in the gallery is fewer than a predetermined value (e.g., 10).

Here, the predetermined value can be set for stable gallery operation in a limited computing environment, and can be set considering the computing environment.

For example, if the assigned identifier for the first identifier is the first identifier, the feature management unit 230 can store the first identifier and the first feature in the gallery to include the first object, which is the new object, in the tracking target objects.

In addition, the feature management unit 230 can store or delete a feature in or from the gallery by considering the number of features corresponding to a specific identifier stored in the gallery.

In detail, if the assigned identifier for the first identifier is the second identifier or the third identifier, the feature management unit 230 can store the first feature as a second feature of the second object or a third feature of the third object.

Here, the feature management unit 230 can delete the second feature or the third feature pre-stored in the gallery by considering the number of second features (e.g., 300) or the number of third features (e.g., 300) allowable in the gallery.

For example, if the number of second features or the number of third features exceeds 300, the feature management unit 230 can store or delete the first feature in a first-in-first-out (FIFO) manner.

As another example, if the number of second features or the number of third features exceeds 300, the feature management unit 230 can retain only the features representing the stored features based on K-means clustering and delete the remaining features.

In this way, the present disclosure can enable real-time processing for the object tracking by configuring a dynamic gallery that manages the memory based on a limitation on the number of features stored in the gallery.

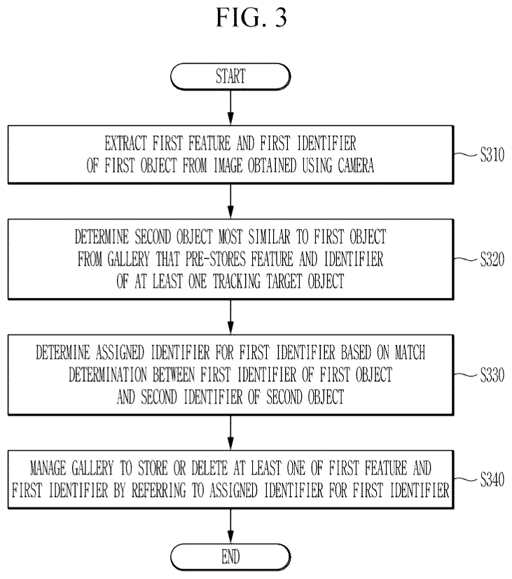

FIG. 3 is a flowchart showing a method for managing a gallery used for multi-camera associated tracking for an arbitrary object according to an Implementation.

Referring to FIG. 3, the feature extraction unit 210 can extract the first feature and first identifier of the first object from the image obtained using the camera (S310).

According to an Implementation, the first feature can be output by inputting the first object image into the object detection model, and include the first bounding box including the first object.

In addition, according to an Implementation, the first identifier can be output by inputting the first feature to the object identification model, and include the first appearance feature vector representing the unique visual feature that can be derived from the appearance of the first object.

Next, the feature determination unit 220 can determine the second object most similar to the first object from the gallery that pre-stores the feature and identifier of at least one tracking target object (S320).

Next, the feature determination unit 220 can determine the assigned identifier for the first identifier based on the match determination between the first identifier of the first object and the second identifier of the second object (S330).

Next, the feature management unit 230 can manage the gallery to store or delete at least one of the first feature and the first identifier by referring to the assigned identifier for the first identifier (S340).

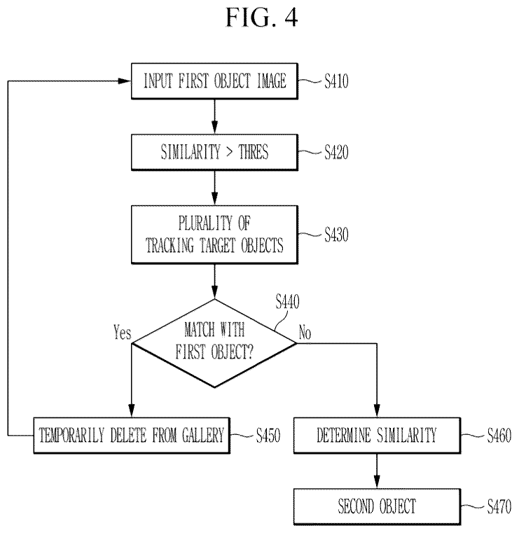

FIG. 4 is a diagram showing an example of determining the second object most similar to the first object when the plurality of tracking target objects have the cosine similarities exceeding the predetermined threshold value according to an Implementation.

Referring to FIG. 4, the apparatus 100 for managing a gallery can receive the first object image obtained using the camera (S410).

The apparatus 100 for managing a gallery can extract the first feature and the first identifier from the first object image, determine the cosine similarity between the feature of at least one tracking target object included in the gallery and the first feature, and compare the determined similarity with the predetermined threshold value (S420).

The apparatus 100 for managing a gallery can determine the plurality of tracking target objects whose cosine similarity exceeds the predetermined threshold value among at least one tracking target object (S430).

If the plurality of tracking target objects have the cosine similarities exceeding the predetermined threshold value, the apparatus 100 for managing a gallery can determine the match between the plurality of tracking target objects and the first object based on the match determination between the identifiers of the plurality of tracking target objects and the first identifier (S440).

If the plurality of tracking target objects and the first object match each other, the apparatus 100 for managing a gallery can temporarily delete the identifiers and features of the plurality of tracking target objects from the gallery (S450). In this way, the cosine similarity determination can not be performed on the object matching the first object.

Meanwhile, if none of the plurality of tracking target objects matches the first object, the apparatus 100 for managing a gallery can compare the features of the objects with each other and determine the cosine similarity (S460), and determine the object having the highest cosine similarity as the second object (S470).

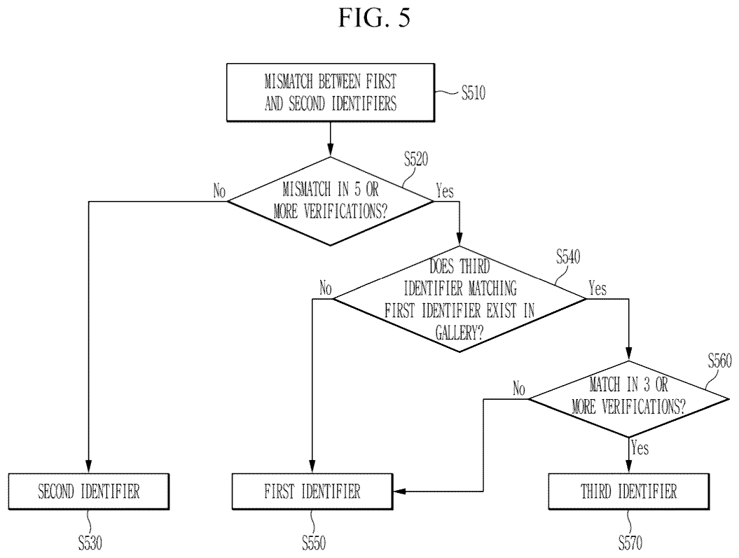

FIG. 5 is a diagram showing an example of determining the assigned identifier for the first identifier based on the match determination between the first identifier of the first object and the second identifier of the second object according to an Implementation.

Referring to FIG. 5, the apparatus 100 for managing a gallery can determine that the first identifier and the second identifier do not match with each other based on the simple match determination between the first identifier of the first object and the second identifier of the second object (S510).

Here, the apparatus 100 for managing a gallery can perform the verification of the match determination between the first identifier and the second identifier five or more times based on the comparison between the predetermined consecutive frames each including the first object and the predetermined consecutive frames each including the second object (S520).

In more detail, in the single verification for the match determination, the apparatus 100 for managing a gallery can determine the number of frames in which the bounding boxes of the first object and the second object overlap with each other (i.e., the overlapping frames) based on the predetermined consecutive frames obtained from each of the first object image and the second object image, and the apparatus 100 for managing a gallery can determine that the first identifier and the second identifier match each other if the number of overlapping frames is greater than or equal to the average number of overlapping frames for the identifiers in the gallery (e.g., 5).

Here, the apparatus 100 for managing a gallery can determine the assigned identifier for the first identifier as the second identifier if verifications of a match determination indicating that the first identifier and the second identifier not matching each other are less than five verifications (S530).

Meanwhile, the apparatus 100 for managing a gallery can determine whether the third identifier matching the first identifier exists in the gallery if the first identifier and the second identifier do not match each other based on five or more verifications (S540).

Here, if the third identifier matching the first identifier does not exist in the gallery, the apparatus 100 for managing a gallery can determine the assigned identifier for the first identifier as the first identifier by treating the first object as the new object (S550).

In addition, if the third identifier matching the first identifier exists in the gallery, the apparatus 100 for managing a gallery can perform the verification of the match determination between the first identifier and the third identifier three or more times based on the comparison between the predetermined consecutive frames each including the first object and the predetermined consecutive frames each including the third object (S560).

Here, the apparatus 100 for managing a gallery can determine the assigned identifier for the first identifier as the first identifier if the first identifier and the third identifier do not match each other based on three or more verifications.

In addition, the apparatus 100 for managing a gallery can determine the assigned identifier for the first identifier as the third identifier if the first identifier and the third identifier match each other based on fewer than three verifications (S570).

In the present disclosure, the primary comparison can first be performed with the most similar object based on the unique feature and identifier of the specific object, and the secondary comparison can then be performed with all the objects included in the gallery through the recursive verification process, thereby determining an optimal identifier. This configuration can effectively prevent the duplicate identifiers from being assigned to the objects matching each other.

Combinations of each block in the block diagram and each step in the flowchart, accompanying to the present disclosure, can be performed using computer program instructions. The computer program instructions can be loaded onto an encoding processor of a general-purpose computer, a special-purpose computer, or another programmable data processing device. Accordingly, these instructions performed by the encoding processor of the computer or another programmable data processing device can provide a method to perform the functions described in each block in the block diagram or each step in the flowchart. These computer program instructions can also be stored in a computer-available or computer-readable memory that can direct the computer or another programmable data processing device to implement a corresponding function in a particular method. Therefore, the instructions stored in the computer-available or computer-readable memory can also produce a manufactured article that includes the instruction methods to perform the function described in each block in the block diagram or each step in the flowchart. The computer program instructions can also be loaded onto the computer or another programmable data processing device. Therefore, a series of operational steps can be performed by the computer or another programmable data processing device to provide a process executed by the computer. Accordingly, the instructions that cause the process to be executed by the computer or the programmable data processing device can provide steps for performing the function described in each block in the block diagram or each step in the flowchart.

In some implementations, the processor (e.g., processor 110) discussed in the present disclosure may include one or more processors. In some implementations, all of the functions of the processor may be performed by a single processor. In other implementations, the functions of the processor may be distributed among multiple processors (e.g., one processor performs a subset of the functions of the processor 110 while one or more other processors perform the remaining functions of the processor 110.)

In addition, each block or step can represent a portion of a module, a segment, or a code that includes at least one executable instruction that causes execution of a specified logical function(s). In addition, it should be noted that, in some alternative Implementations, the functions described in the blocks or steps can occur out of order. For example, two blocks or steps shown in succession can actually be performed substantially simultaneously, or the blocks or steps can sometimes be performed in a reverse order depending on the corresponding function.

The spirit of the present disclosure is illustratively described hereinabove. It will be appreciated by those skilled in the art that various modifications and alterations can be made without departing from the spirit and scope of the present disclosure. Accordingly, the Implementations of the present disclosure are not intended to limit the spirit of the present disclosure, but rather to describe the same, and the spirit and scope of the present disclosure are not limited to the Implementations described above. Therefore, the scope of the present disclosure should be interpreted by the following claims, and it should be interpreted that all the spirits equivalent to the following claims fall within the scope of the present disclosure.

What is claimed is:

1. A method for managing a gallery for multi-camera associated tracking of an arbitrary object, the method comprising:
extracting a first feature and a first identifier of a first object from an image obtained using a camera;
determining a second object most similar to the first object from a gallery configured to pre-store a feature and an identifier of at least one tracking target object;
determining an assigned identifier for the first identifier based on a match determination between the first identifier of the first object and a second identifier of the second object; and
managing the gallery to store or delete at least one of the first feature or the first identifier by referring to the assigned identifier for the first identifier.

2. The method of claim 1, wherein extracting the first feature and the first identifier of the first object includes:
extracting the first feature by inputting an image into an object detection model, and
extracting the first identifier by inputting the extracted first feature to an object identification model.

3. The method of claim 1, wherein determining the second object most similar to the first object includes:
determining cosine similarity between the feature of the at least one tracking target object and the first feature, and
determining, among the at least one tracking target object, a first tracking target object whose cosine similarity exceeds a predetermined threshold value as the second object.

4. The method of claim 3, wherein based on a plurality of tracking target objects having cosine similarities exceeding the predetermined threshold value,
determining the first tracking target object as the second object includes:
determining a match between the plurality of tracking target objects and the first object based on a match determination between identifiers of the plurality of tracking target objects and the first identifier, and
determining an object different from the first object among the plurality of tracking target objects as the second object by referring to the cosine similarity.

5. The method of claim 1, wherein based on the first identifier and the second identifier not matching each other,
determining the assigned identifier for the first identifier includes performing verification of the match determination between the first identifier and the second identifier based on a comparison between a first group of predetermined consecutive frames each including the first object and a second group of predetermined consecutive frames each including the second object.

6. The method of claim 5, wherein determining the assigned identifier for the first identifier includes determining the assigned identifier for the first identifier as the second identifier based on verifications of a match determination indicating that the first identifier and the second identifier not matching each other less than a predetermined number of verifications.

7. The method of claim 6, wherein determining the assigned identifier for the first identifier includes determining the assigned identifier for the first identifier as the first identifier based on the first identifier not matching either the second identifier or a third identifier of a third object included in the gallery based on a predetermined number or more verifications.

8. The method of claim 7, wherein determining the assigned identifier for the first identifier includes determining the assigned identifier for the first identifier as the third identifier based on the first identifier not matching the second identifier and matching the third identifier based on the predetermined number or more verifications.

9. The method of claim 8, wherein based on the assigned identifier for the first identifier being the first identifier, managing the gallery includes storing the first identifier and the first feature in the gallery to include the first object in the at least one tracking target object.

10. The method of claim 8, wherein based on the assigned identifier for the first identifier being the second identifier or the third identifier, managing the gallery includes:
storing the first feature as a second feature of the second object or a third feature of the third object, and
deleting the second feature or the third feature pre-stored in the gallery by considering a number of second features or a number of third features allowable in the gallery.

11. An apparatus configured to manage a gallery for multi-camera associated tracking of an arbitrary object, the apparatus comprising:
a memory configured to store a program for managing a gallery; and
one or more processors configured to load the program for managing the gallery from the memory and execute the program for managing the gallery,
wherein the one or more processors are configured to:
extract a first feature and a first identifier of a first object from an image obtained using a camera,
determine a second object most similar to the first object from the gallery configured to pre-store a feature and an identifier of at least one tracking target object,
determine an assigned identifier for the first identifier based on a match determination between the first identifier of the first object and a second identifier of the second object, and
manage the gallery to store or delete at least one of the first feature or the first identifier by referring to the assigned identifier for the first identifier.

12. The apparatus of claim 11, wherein the one or more processors are configured to:
extract the first feature by inputting an image into an object detection model, and
extract the first identifier by inputting the extracted first feature to an object identification model.

13. The apparatus of claim 11, wherein the one or more processors are configured to:
determine cosine similarity between the feature of the at least one tracking target object and the first feature, and
determine, among the at least one tracking target object, a first tracking target object whose cosine similarity exceeds a predetermined threshold value as the second object.

14. The apparatus of claim 11, wherein based on the first identifier and the second identifier not matching each other, the one or more processors are configured to perform verification of the match determination between the first identifier and the second identifier based on a comparison between a first group of predetermined consecutive frames each including the first object and a second group of predetermined consecutive frames each including the second object.

15. The apparatus of claim 14, wherein the one or more processors are configured to determine the assigned identifier for the first identifier as the second identifier based on verifications of a match determination indicating that the first identifier and the second identifier not matching each other less than a predetermined number of verifications.

16. The apparatus of claim 15, wherein the one or more processors are configured to determine the assigned identifier for the first identifier as the first identifier based on the first identifier not matching either the second identifier or a third identifier of a third object included in the gallery based on a predetermined number or more verifications.

17. The apparatus of claim 16, wherein the one or more processors are configured to determine the assigned identifier for the first identifier as the third identifier based on the first identifier not matching the second identifier and matching the third identifier based on the predetermined number or more verifications.

18. The apparatus of claim 17, wherein based on the assigned identifier for the first identifier being the first identifier, the one or more processors are configured to store the first identifier and the first feature in the gallery to include the first object in the at least one tracking target object.

19. The apparatus of claim 17, wherein based on the assigned identifier for the first identifier being the second identifier or the third identifier, the one or more processors are configured to:
store the first feature as a second feature of the second object or a third feature of the third object, and
delete the second feature or the third feature pre-stored in the gallery by considering the number of second features or the number of third features allowable in the gallery.

20. A non-transitory computer-readable recording medium storing a computer program, wherein the computer program includes an instruction that causes one or more processors to perform a method for managing a gallery when executed by the one or more processors, the method including:
extracting a first feature and a first identifier of a first object from an image obtained using a camera,
determining a second object most similar to the first object from a gallery configured to pre-store a feature and an identifier of at least one tracking target object,
determining an assigned identifier for the first identifier based on a match determination between the first identifier of the first object and a second identifier of the second object, and
managing the gallery to store or delete at least one of the first feature or the first identifier by referring to the assigned identifier for the first identifier.
